(19) United States
(12) Patent Application Publication
(10) Pub. No.: US 2015/0336576 A1
(43) Pub. Date: Nov. 26, 2015

(54) UNMANNED VEHICLE DRIVING APPARATUS AND METHOD FOR OBSTACLE AVOIDANCE

(71) Applicant: Electronics and Telecommunications Research Institute, Daejeon-si (KR)

(72) Inventors: Kyung Bok SUNG, Daejeon-si (KR); Ju Wan KIM, Daejeon-si (KR); Kyoung Wook MIN, Sejong-si (KR); Jeong Dan CHOI, Daejeon-si (KR); Hyun Kyun CHOI, Daejeon-si (KR); Seung Jun HAN, Daejeon-si (KR)

(73) Assignee: Electronics and Telecommunications Research Institute, Daejeon-si (KR)

(21) Appl. No.: 14/597,722

(22) Filed: Jan. 15, 2015

(30) Foreign Application Priority Data
May 23, 2014 (KR) 10-2014-0062612

(51) Int. Cl. B60W 30/09; G01C 21/34

(52) U.S. Cl. CPC B60W 30/09; G01C 21/34

(57) ABSTRACT

An unmanned vehicle driving apparatus which allows obstacle avoidance and the method of it is commenced. The unmanned vehicle driving apparatus according to an exemplary embodiment include: a routing part which generates or receives a vehicle's fundamental driving route and generates a moved-driving route by adding or subtracting a route changing value to the fundamental driving route to avoid obstacles while driving; an obstacle detecting part which detects obstacles while driving; and a route driving part which drives the vehicle on the fundamental driving route and when an obstacle is detected, drives the vehicle on the moved-driving route to avoid it.

### CROSS-REFERENCE TO RELATED APPLICATION(S)

This application claims priority from Korean Patent Application No. 10-2014-0062612, filed on May 23, 2014, in the Korean Intellectual Property Office, the entire disclosure of which is incorporated herein by reference for all purposes.

### BACKGROUND

1. Field

The following description relates to an unmanned vehicle homing guidance technology, and more particularly, to a technology for an automatic obstacle avoidance of unmanned vehicle.

2. Description of the Related Art

As industrialization accelerates and the usage of vehicles is being frequent, vehicles are a part of our everyday lives. Hence, in an increasing tendency of pursuing agreement and convenience, there have been researches on vehicles not only on its transportation capabilities, but also in its provision of comforts.

One of the researches is on an unmanned vehicle driving technology, which allows the vehicle to drive automatically without drivers' control. The unmanned vehicle driving technology is the technology to drive automatically by apprehending surrounding conditions of the vehicle, as well as the condition of the vehicle itself, by using an electric sensor that can replace a human's sense.

Currently, the development in the unmanned vehicle is only at the stage of driving by sensing the front. For instance, it is a simple driving method to avoid obstacles by stopping the vehicle when an obstacle is detected, while driving without deviating from its detected-inside lane by unmanned camera. Additionally, there is a technology to generate and drive on a new route that can avoid obstacles. However, such technology has difficulty in vehicle control due to the inconsistency of the driving route, and complexity in computational procedures for generating the new route.

### SUMMARY

An exemplary embodiment suggests an unmanned vehicle driving apparatus and method for an obstacle avoidance which does not generate a new route to avoid existing obstacles around the vehicle during unmanned driving, but avoid them easily by simply changing a fundamental driving route.

In one general aspect, there is provided an unmanned vehicle driving apparatus including: a routing part which generates or receives a vehicle's fundamental driving route and generates a moved-driving route by adding or subtracting a route changing value to the fundamental driving route to avoid obstacles while driving; an obstacle detecting part which detects obstacles while driving; and a route driving part which drives the vehicle on the fundamental driving route and when an obstacle is detected, drives the vehicle on the moved-driving route to avoid it.

In yet another general aspect, there is provided a method for an unmanned vehicle driving including: generating or receiving the vehicle's fundamental driving route and operating on the fundamental driving route; detecting the obstacle while driving; adding or subtracting the route changing value to the fundamental driving route contingent upon the obstacle detection;

and driving the vehicle on the moved-driving route to avoid the detected obstacle.

### BRIEF DESCRIPTION OF THE DRAWINGS

FIG. 1 is a block diagram illustrating an unmanned vehicle driving apparatus according to an exemplary embodiment.

FIG. 2 is a diagram illustrating an example of a fundamental driving route and an obstacle detection boundary according to an exemplary embodiment.

FIG. 3 is a diagram illustrating an example of a moved-driving route when the unmanned vehicle driving apparatus perceived an obstacle according to an exemplary embodiment.

FIG. 4 is a diagram illustrating an example of restoring to the fundamental driving route as vehicle passes the obstacle according to an exemplary embodiment.

FIG. 5 is a diagram illustrating an example of avoiding the obstacle on a curved road according to an exemplary embodiment.

FIG. 6 is a flowchart illustrating a method for an unmanned vehicle driving according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

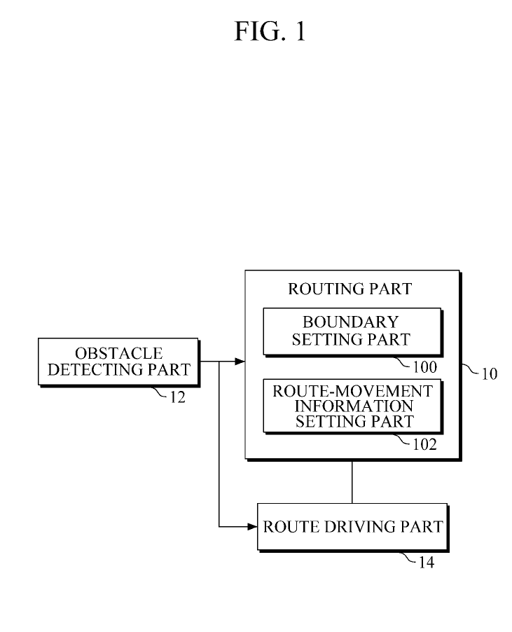

FIG. 1 shows a block diagram illustrating an unmanned vehicle driving apparatus according to an exemplary embodiment. The unmanned vehicle driving apparatus is an assist device which drives the vehicle automatically, with or without a driver in the vehicle, without driver's control. As illustrated in FIG. 1, the unmanned vehicle driving apparatus consists of a routing part 10, an obstacle detecting part 12, and a route driving part 14. The routing part 10, the obstacle detecting part 12, and the route driving part 14; as hardware, those are placed in a processor to carry out the corresponding function; and as software, those can be embodied as a coded program.

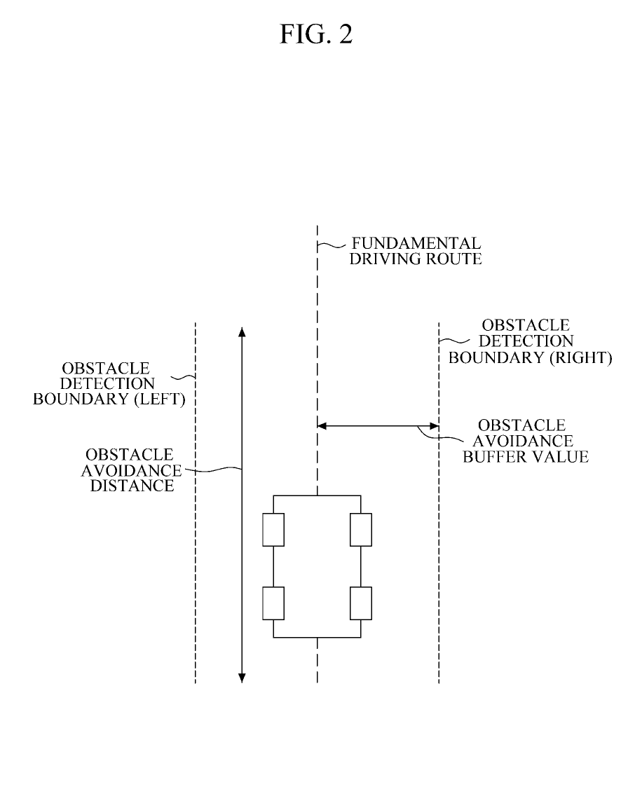

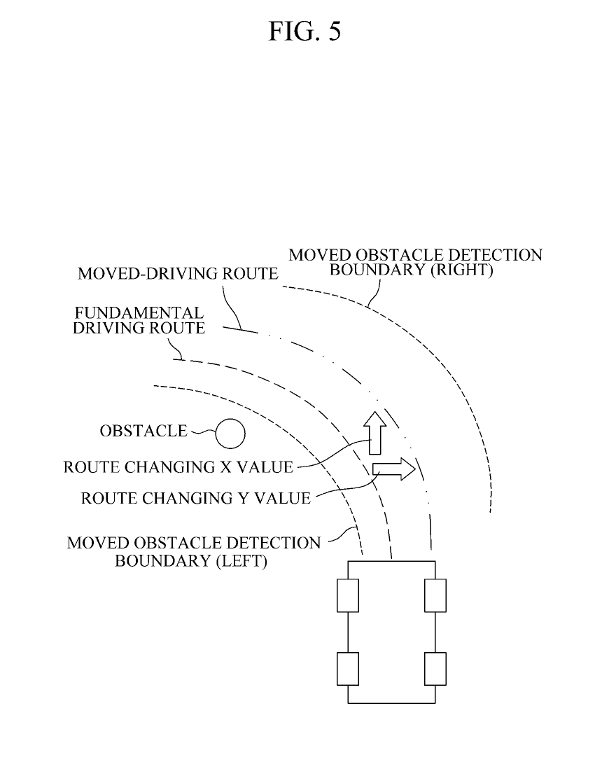

The routing part 10 generates the vehicle's fundamental driving route or receives the fundamental driving route from the server. The fundamental driving route is the path required for the vehicle to drive to the destination. The fundamental driving route is generated before the vehicle starts its operation, then the vehicle carries out the unmanned driving based on this fundamental driving route. The routing part 10 generates a moved-driving route to avoid obstacles while driving. The moved-driving route can be generated by transferring the fundamental driving route by an amount of the route changing value. The example of the fundamental driving route and the moved-driving route will be mentioned later by referring to FIG. 2 and FIG. 5.

According to the unmanned vehicle driving apparatus, it is not necessary to generate a new route to avoid existing obstacles during the unmanned vehicle driving, instead, avoid them by driving on the moved-driving route, which is the fundamental driving route transferred by the amount of the route changing value. Hence, it is feasible to do the obstacle avoidance driving without generating the new route.

The obstacle detecting part 12 detects the obstacle while driving. The obstacle detecting part 12 emits a laser beam by using radar, and then detects the obstacle by using a heliogram from the obstacle. However, the method of the obstacle detection is not limited to a certain method.

The obstacle detecting part 12 according to an exemplary embodiment measures the distance from the vehicle to the obstacle. For instance, said obstacle detecting part 12, when using the radar to detect the obstacle, can measure the distance to the obstacle by measuring the time taken for the emitted beam to return. Also, a vehicle speed sensor can be used to get the distance between the vehicle and the obstacle, relative velocity, and so on; however, not limited to it.

The route driving part 14 drives the vehicle on the fundamental driving route in general situations; and when the obstacle is detected, drive the vehicle on the moved-driving route to avoid the obstacle. When the obstacle is successfully avoided, it drives the vehicle back to the fundamental driving route.

Below, the routing part 10 will be described in detail. The routing part 10 according to an exemplary embodiment increases the route changing value in phases when the obstacle is detected from the obstacle detecting part 12, and reduces the route changing value in phases until it reaches 0 (zero) as the vehicle passes the detected obstacle. In this context, ‘in phases’ means a gradual increase or decrease in the route changing value, and the level of ‘gradually’ can be set in advance by the user. The route changing value can have an X-value and a Y-value respectively with the vehicle as a directional reference. Moreover, in order not to let the route changing value increase infinitely, the maximum route changing value can be set to have a limitation.

The routing part 10 according to an exemplary embodiment comprising a boundary setting part 100 and a route-movement information setting part 102 as illustrated in FIG. 1.

The boundary setting part 100 generates an obstacle detection boundary on right and left sides of the fundamental driving route. The boundary setting part 100 according to an exemplary embodiment generates the obstacle detection boundary on right and sides of the fundamental driving route by using a perceived obstacle avoidance distance and an obstacle avoidance buffer value and alters the obstacle detection boundary in response to the change in the route changing value. The perceived obstacle avoidance distance can be generated by using information about a length and a velocity of the vehicle. The obstacle avoidance buffer value can be generated by using information about a width and a velocity of the vehicle. The perceived obstacle avoidance distance and the obstacle avoidance buffer value can be set in advance of the vehicle driving. The example of the obstacle detection boundary will be described later by referring to FIG. 2.

The route-movement information setting part 102 alters the route changing value contingent upon detection of the obstacle within the obstacle detection boundary, which is generated by the boundary setting part 100. For instance, when the obstacle is detected in front of the vehicle within the obstacle detection boundary, said route-movement information setting part 102 increases the route changing value in phases, from a positive direction to the a negative direction, until the detected obstacle disappears within the obstacle detection boundary. The choice between positive and negative direction can be made by choosing the left space for the vehicle to go forward, when avoiding the obstacle, is larger. Furthermore, the route-movement information setting part 102 decreases the route changing value to zero in phases to restore the vehicle to the fundamental driving route when the obstacle no longer is detected in front of the vehicle within the changed-obstacle detection boundary, in response to the change in the route changing value.

The route-movement information setting part 102 according to an exemplary embodiment sets the maximum route changing value in advance. When the obstacle is detected from the obstacle detecting part 12, the route driving part 14 can increase the route changing value to the preset maximum value. However, when the vehicle cannot avoid the obstacle even after reaching the maximum route changing value, the route driving part 14 determines that is the vehicle is having difficulty in avoiding the obstacle, hence, stops the vehicle and sends a warning message.

The obstacle detecting part 12, according to an exemplary embodiment, when there are a plurality of obstacles, measures the relative distance between the fundamental driving route and each of the obstacles; and the route-movement information setting part establishes the route changing value by using the middle point of the longest relative distance, measured by the obstacle detecting part, as a fiducial point.

FIG. 2 is a diagram illustrating an example of the fundamental driving route and the obstacle detection boundary according to an exemplary embodiment.

As illustrated in FIG. 2, the unmanned vehicle drives on the fundamental driving route in general situations. When the fundamental driving route is given, based on the given fundamental driving route, generates the obstacle detection boundary on right and left sides of the fundamental driving route by using the perceived obstacle avoidance distance and the obstacle avoidance buffer value. The perceived obstacle avoidance distance and the obstacle avoidance buffer value are set in advance. The perceived obstacle avoidance distance can be generated by using information about the length and the velocity of the vehicle and the obstacle avoidance buffer value can be generated by using information about the width and the velocity of the vehicle.

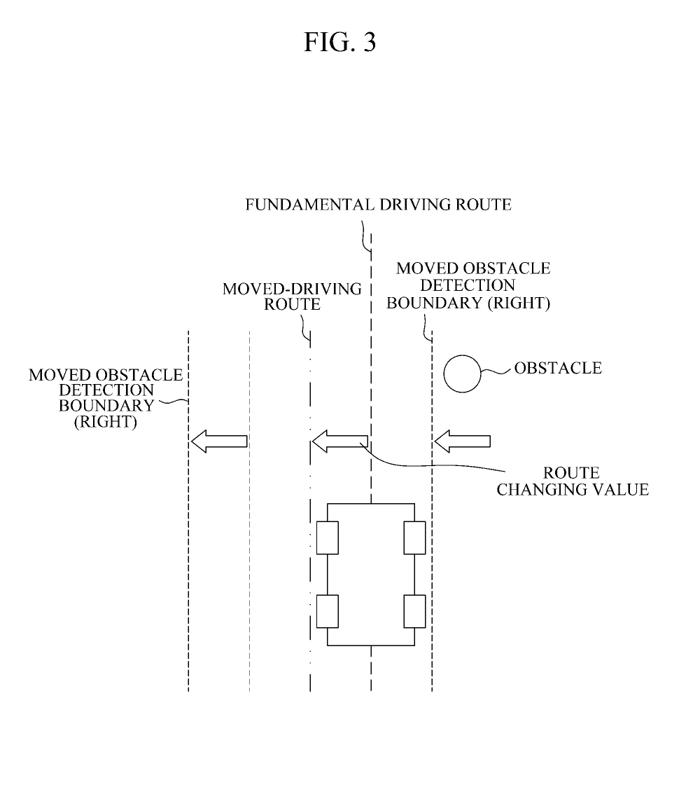

FIG. 3 is a diagram illustrating an example of the moved-driving route when the unmanned vehicle driving apparatus perceived the obstacle according to an exemplary embodiment.

As illustrated in FIG. 3, when there are obstacle detection boundaries on right and left sides of the fundamental driving route and the obstacle is existing in front of the vehicle within the obstacle detection boundaries; the unmanned vehicle driving apparatus generates the moved-driving route by adding or subtracting the route changing value to the fundamental driving route; and drives the vehicle on the generated moved-driving route to avoid the obstacle. The obstacle detection boundary changes in response to the change in the route changing value.

As previously stated, the unmanned vehicle driving apparatus does not generate the new route to avoid the existing obstacle, but avoid it by driving on the moved-driving route, which is the fundamental driving route transferred by the amount of the route changing value. Hence, it is feasible to do the obstacle avoidance driving without generating the new route.

The unmanned vehicle driving apparatus according to an exemplary embodiment increases the route changing value in phases when the obstacle is detected in front of the vehicle within the obstacle detection boundary. Moreover, in order not to let the unmanned vehicle driving apparatus drive the vehicle endlessly, the maximum route changing value can be fixed to cut off the infinite growth of the route changing value. If the vehicle cannot avoid the obstacle, even though the route changing value is equal to the preset maximum route changing value, the vehicle is determined to be incapable of avoiding the obstacle, the vehicle stops and waits until the obstacle disappears or uses a different method for the obstacle avoidance.

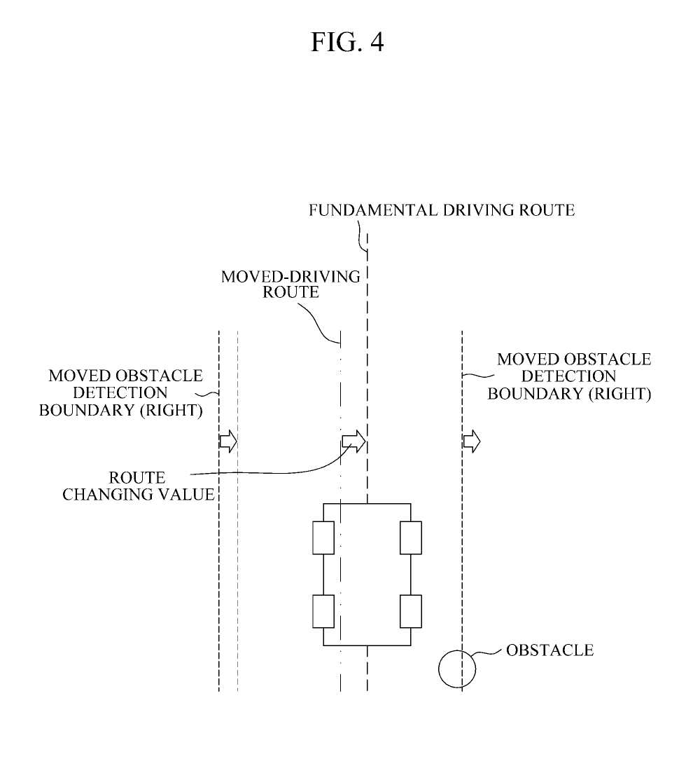

FIG. 4 is a diagram illustrating an example of restoring the fundamental driving route as a vehicle passes the obstacle according to an exemplary embodiment.

As illustrated in FIG. 4, as previously stated by referring to FIG. 3, the unmanned vehicle driving apparatus, after increasing the route changing value to avoid the obstacle checks whether there are any obstacles detected within the changed obstacle detection boundary, in response to the change in route changing value. When no more obstacles are detected, the vehicle is determined to have successfully avoided the obstacle, and the route changing value is decreased in phases to restore the vehicle to the fundamental driving route.

FIG. 5 is a diagram illustrating an example of avoiding the obstacle on a curved road according to an exemplary embodiment.

As illustrated in FIG. 5, the route changing value according to an exemplary embodiment has the X-value and the Y-value respectively with the vehicle as a directional reference. As shown in FIG. 5, the vehicle cannot avoid the obstacle by using only one axis when the obstacle appears while driving on the curved road, hence, it should move to both the X- and the Y-direction. Therefore the route changing value keeps both of the X- and the Y-value.

When the obstacle is detected, the route changing value is increased in phases, and when the obstacle no more exists in front of the vehicle, stops increasing the route changing value. Then if the obstacle does not exist anymore, reduces the route changing value in phases until it reaches 0.

When there are obstacles on both right and left sides, each distance between the fundamental driving route and the obstacles is measured and the route changing value is set by using the middle point of the longest relative distance as a fiducial point. Hence, the vehicle is enabled to pass through the middle of the obstacles on both sides.

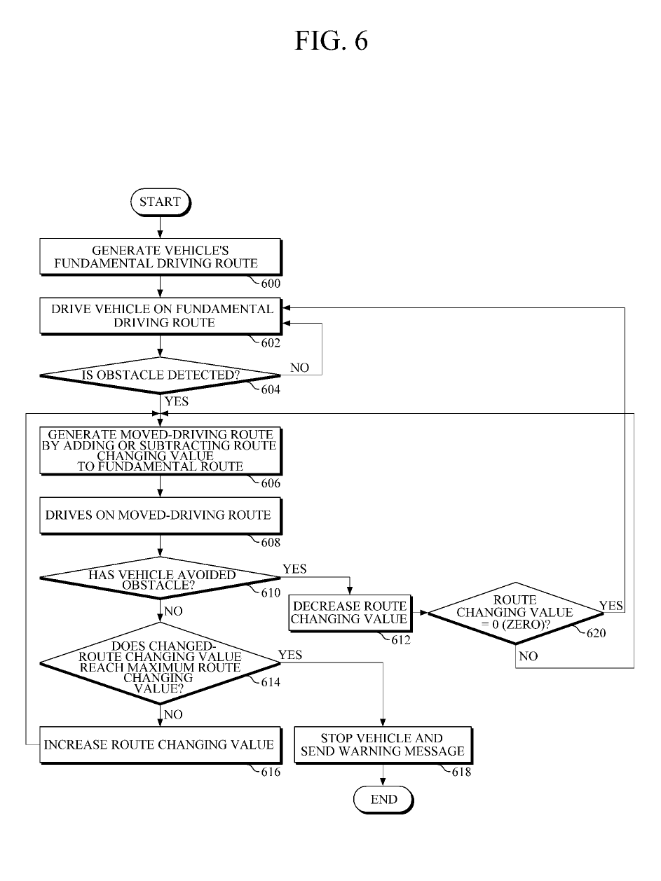

FIG. 6 is a flowchart illustrating a method for the unmanned vehicle driving according to an exemplary embodiment.

As illustrated in FIG. 6, the unmanned vehicle driving generates the vehicle's fundamental driving route or receives it from the outside in 600 and drives the vehicle on the fundamental driving route in 602. Furthermore, the obstacle to avoid is detected while driving on the fundamental driving route in 604. The unmanned vehicle driving apparatus according to an exemplary embodiment generates the obstacle detection boundary on right and left sides of the fundamental driving route, and detects whether there is any obstacle in front of the vehicle within said obstacle detection boundary. The obstacle detection boundary can be generated on right and left side of the fundamental driving route, by using the perceived obstacle avoidance distance and the obstacle avoidance buffer value.

If no obstacle is being detected while driving on the fundamental driving route, the vehicle continues driving on the fundamental driving route in 602. In contrast, when an obstacle is detected, the unmanned vehicle driving apparatus generates the moved-driving route by adding or subtracting the route changing value to the fundamental route in 606 and drives on the moved-driving route in 608. The unmanned vehicle driving apparatus according to an exemplary embodiment, when the obstacle is detected, increases the route changing value in phases until the detected obstacle no longer exists within the obstacle detection boundary.

Subsequently, continuous detection of the obstacle in front of the vehicle on the moved-driving route is performed. In other words, whether the vehicle has avoided the obstacle or not is determined in 610. If it is judged that the vehicle has successfully avoided an obstacle, the increased route changing value is decreased in phases to restore the vehicle to the fundamental driving route in 612, and whether the value is 0 (zero) is checked in 620. If the route changing value is not 0 (zero), the vehicle continues driving on the moved-driving route, which added or subtracted the reduced-route changing value in 606,608; and when the route changing value reaches 0 (zero), it drives on the fundamental driving route in 602. In judging whether or not the vehicle has avoided the obstacle in 610, if it is judged that the vehicle has failed to avoid the obstacle, in other words, when the obstacle is still being detected within the changed-obstacle detection boundary in response to the change in route changing value, whether the changed-route changing value is bigger than the maximum route changing value is checked in 614. If the changed-route changing value is smaller than the maximum route changing value, the route changing value is increased in 616, and the moved-driving route is generated by adding or subtracting the increased route changing value in 606 and the vehicle drives on the generated moved-driving route in 608. In contrast, when the route changing value reaches the maximum route changing value, the vehicle is judged to be unable to avoid the obstacle, the vehicle is stopped to avoid the obstacle, and a warning message is sent in 618.

According to an exemplary embodiment, it is feasible to avoid obstacles without forming a new obstacle-avoidance route against the existing obstacles around the vehicle during unmanned driving. Therefore, the computational procedure for generating the obstacle avoidance route can be simplified, and it is possible to avoid obstacles without being far from the driving route when an obstacle is detected during unmanned driving. The apparatus can be utilized not only for the unmanned vehicle, but also for every autonomous machinery as it can avoid existing obstacles under the given fundamental route.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An unmanned vehicle driving apparatus comprising:
a routing part which generates or receives a vehicle's fundamental driving route and generates a moved-driving route by adding or subtracting a route changing value to the fundamental driving route to avoid obstacles while driving;
an obstacle detecting part which detects obstacles while driving; and
a route driving part which drives the vehicle on the fundamental driving route and when an obstacle is detected, drives the vehicle on the moved-driving route to avoid the detected obstacle.

2. The unmanned vehicle driving apparatus of claim 1, wherein the moved-driving route is the fundamental driving route transferred by an amount of the route changing value.

3. The unmanned vehicle driving apparatus of claim 1, wherein the route changing value has an X-value and a Y-value respectively with the vehicle as a directional reference.

4. The unmanned vehicle driving apparatus of claim 1, wherein the routing part increases the route changing value in phases when the obstacle is detected, and reduces the value until it reaches 0 as the vehicle passes the detected obstacle.

5. The unmanned vehicle driving apparatus of claim 1, wherein the routing part comprises:
a boundary setting part which generates an obstacle detection boundary on right and left sides of the fundamental driving route; and
a route-movement information setting part which alters the route changing value, contingent upon detection of the obstacle within the obstacle detection boundary while driving.

6. The unmanned vehicle driving apparatus of claim 5, wherein the boundary setting part generates the obstacle detection boundary on right and left sides of the fundamental driving route by using a perceived obstacle avoidance distance and an obstacle avoidance buffer value, and alters the obstacle detection boundary in response to the change in the route changing value.

7. The unmanned vehicle driving apparatus of claim 6, wherein the perceived obstacle avoidance distance can be generated by using information about a length and a velocity of the vehicle.

8. The unmanned vehicle driving apparatus of claim 6, wherein the obstacle avoidance buffer value can be generated by using information about a width and the velocity of the vehicle.

9. The unmanned vehicle driving apparatus of claim 5, wherein the route-movement information setting part increases the route changing value in phases until the detected obstacle no longer exists, when the obstacle is detected in front of the vehicle within the obstacle detection boundary.

10. The unmanned vehicle driving apparatus of claim 9, wherein the route-movement information setting part, after the increase in the route changing value to avoid the obstacle, decreases the route changing value in phases to restore the vehicle to the fundamental driving route, when the obstacle is no longer detected in front of the vehicle within the changed obstacle detection boundary in response to the change in the route changing value.

11. The unmanned vehicle driving apparatus of claim 5, wherein:
the route-movement information setting part sets the maximum route changing value in advance and increases the value to the preset maximum route changing value when the obstacle is detected from the obstacle detecting part, and
the route driving part stops the vehicle and sends a warning message when the vehicle cannot avoid the obstacle even if it is driving on the moved-driving route with the maximum route changing value.

12. The unmanned vehicle driving apparatus of claim 5, wherein:
the obstacle detecting part, when there are a plurality of the obstacles, measures the relative distance between the fundamental driving route and each of the obstacles, and
the route-movement information setting part establishes the route changing value by using the middle point of the longest relative distance, measured by the obstacle detecting part as a fiducial point.

13. A method for an unmanned vehicle driving, the method comprising:
generating or receiving the vehicle's fundamental driving route and operating on the fundamental driving route;
detecting the obstacle while driving;
adding or subtracting the route changing value to the fundamental driving route contingent upon the obstacle detection; and
driving the vehicle on the moved-driving route to avoid the detected obstacle

14. The method of claim 13, wherein the route changing value increases in phases when the obstacle is detected, and gradually reduces until it reaches 0 as the vehicle passes the detected obstacle.

15. The method of claim 13, wherein the producing of the moved-driving route comprises:
forming the obstacle detection boundary on right and left side of the fundamental driving route; and
altering the route changing value, contingent upon detection of the obstacle within the generated obstacle detection boundary.

16. The method of claim 15, wherein the forming of the obstacle detection boundary is to generate the obstacle detection boundary on right and left sides of the fundamental driving route by using the perceived obstacle avoidance distance and the obstacle avoidance buffer value and to alter the obstacle detection boundary in response to the change in the route changing value.

17. The method of claim 15, wherein the altering of the route changing value is to increase the route changing value in phases when the obstacle is detected, until the detected obstacle no longer exists in front of the vehicle within the obstacle detection boundary.

18. The method of claim 17, wherein the altering of the route changing value is to decrease the route changing value in phases, after the increase in the route changing value to avoid the obstacle, to restore the vehicle to the fundamental driving route when the obstacle is no longer detected in front of the vehicle within the changed obstacle detection boundary, in response to the change in the route changing value.

19. The method of claim 13, further comprising:
setting the maximum route changing value in advance; and
stopping the vehicle and sending the warning message to avoid the obstacle, when the route changing value increases up to its designated maximum level.

20. The method of claim 13, further comprising:
computing the relative distance between the fundamental driving route and each of the obstacles, when there are a plurality of obstacles; and
is setting the route changing value by using the middle point of the longest relative distance as a fiducial point.
